(19) United States
(12) Patent Application Publication
(10) Pub. No.: US 2004/0115337 A1
(43) Pub. Date: Jun. 17, 2004

(54) Apparatus and method for inspecting crystal quality of a polysilicon film

(75) Inventors: Yi-Chang Tsao, Hsinchu (TW); Long-Sheng Liao, Jungli City (TW)

Correspondence Address: Richard P. Berg, Esq., c/o LADAS & PARRY, Suite 2100, 5670 Wilshire Boulevard, Los Angeles, CA, 90036-5679, US

(73) Assignee: AU Optronics Corp.

(21) Appl. No.: 10/607,607

(22) Filed: Jun. 27, 2003

(30) Foreign Application Priority Data
Oct. 21, 2002 (TW) 91124255

(51) Int. Cl. B05D 3/06; G01J 5/00

(52) U.S. Cl. 427/8; 427/508; 427/558; 427/559; 250/372

(57) ABSTRACT

A method for inspecting crystal quality of a polysilicon film. First, a substrate covered by a polysilicon layer is provided. Next, a probe light beam having a predetermined wavelength is irradiated through a beam splitter to separate into a first light beam and a second light beam, which is used for irradiating the polysilicon layer. Thereafter, the light intensity of the first light beam and the light intensity of the second light beam reflected from the polysilicon layer are detected to achieve a light intensity ratio. Finally, crystal quality of the polysilicon layer is monitored by the light intensity ratio. An apparatus for inspecting crystal quality of a polysilicon film and the method for controlling the same are also disclosed.

### BACKGROUND OF THE INVENTION

1. Field of the Invention

The invention relates to an apparatus and a method for inspecting a semiconductor film, and more particularly to an apparatus and method for inspecting a polysilicon film, thereby monitoring crystal quality of the polysilicon film.

2. Description of the Related Art

Currently, thin film transistor-liquid crystal display (TFT-LCD) technology mainly adopts two kinds of thin-film for fabricating transistors. One is amorphous silicon film, and the other is polysilicon film. The polysilicon thin film transistor (TFT) possesses the advantage of having electron mobility 10˜100 times higher than that of amorphous silicon TFT. Therefore, there has been studied and developed a drive circuit integrated TFT-LCD using polysilicon TFT as a pixel switching element or a peripheral drive circuit for an LCD.

Polysilicon TFT is fabricated by a low temperature polysilicon (LTPS) process. In the LPTS technology, a polysilicon film is formed by performing excimer laser annealing (ELA) on an amorphous silicon film. Since the process temperature is below 600° C., this technology can be applied to a transparent glass substrate. In general, the electron mobility of polysilicon TFT is dependent on crystal quality of a polysilicon film. That is, the electron mobility of polysilicon TFT increases by increasing the grain size of a polysilicon film. In addition, the grain size of a polysilicon film is related to the laser energy density applied to the amorphous silicon film. Accordingly, it is necessary to measure the grain size of a polysilicon film, thereby regulating the applied laser energy density to achieve optimal crystal quality in the polysilicon film.

Conventionally, there is a well known method for observing the surface roughness of a polysilicon film using an optical microscope (OM) with a magnification of approximately 500˜1000 to serve as a grain size index. However, since this method relies mainly on the human eye, the measured result is imprecise. Another conventional inspection method adopts a scanning electron microscope (SEM) to measure the grain size of a polysilicon film. This method, however, is destructive and excessive time is spent on sample fabrication and inspection, thereby decreasing throughput.

### SUMMARY OF THE INVENTION

Accordingly, an object of the invention is to provide a novel method for inspecting crystal quality of a polysilicon film and an apparatus for inspecting the same that avoids the conventional off-line destructive inspection, precisely and quickly monitors crystal quality of a polysilicon film, thereby increasing throughput.

According to the object of the invention, a method for inspecting crystal quality of a polysilicon film is provided. First, a substrate covered by a polysilicon layer is provided. Next, a probe light beam having a predetermined wavelength is irradiated through a beam splitter to separate into a first light beam and a second light beam, which is used for irradiating the polysilicon layer. Thereafter, the light intensity of the first light beam and the light intensity of the second light beam reflected from the polysilicon layer are detected to achieve a light intensity ratio. Finally, crystal quality of the polysilicon layer is monitored by the light intensity ratio.

Moreover, the probe light beam is a laser beam and the predetermined wavelength is about 266˜316 nm. The split ratio of the first light beam to the second light beam is 30˜40%:70˜60%.

According to the object of the invention, an apparatus for inspecting crystal quality of a polysilicon film is also provided. The apparatus includes beam splitter, first and second detecting devices, and a controlling unit. The beam splitter receives a probe light beam having a predetermined wavelength to separate into a first light beam and a second light beam, which is used for irradiating to a polysilicon layer formed on a substrate. The first detecting device detects the light intensity of the first light beam and the second detecting device detects the light intensity of the second light beam reflected from the polysilicon layer. The controlling unit is coupled between the first and second detecting devices to monitor crystal quality of the polysilicon layer by a light intensity ratio of the first light beam and the second light beam reflected from the polysilicon layer.

Moreover, the probe light beam is a laser beam and the predetermined wavelength is about 266˜316 nm. The split ratio of the first light beam to the second light beam is 30˜40%:70˜60%.

Also, a method for controlling crystal quality of a polysilicon film is provided. First, a first substrate covered by a first amorphous silicon layer is provided. The first amorphous silicon layer is annealed by a laser beam with different first predetermined laser energy densities to form a plurality of polysilicon regions therein. Next, a probe light beam having a predetermined wavelength is irradiated through a beam splitter to separate into a first light beam and a second light beam, which is used for irradiating the polysilicon regions. Next, the light intensity of the first light beam and the light intensity of the second light beam reflected from each polysilicon region are detected to achieve a plurality of light intensity ratios. Thereafter, a second predetermined laser energy density is determined by the light intensity ratios. Next, a second substrate covered by a second amorphous silicon layer is provided. Finally, the second amorphous silicon layer is annealed by the laser beam with the second predetermined laser energy density to form a polysilicon layer on the second substrate.

Moreover, the laser beam is an excimer laser beam and the first predetermined laser energy densities are about 300˜500 mJ/cm².

Moreover, the probe light beam is a laser beam and the predetermined wavelength is about 266˜316 nm. The split ratio of the first light beam to the second light beam is 30˜40%:70˜60%.

### DESCRIPTION OF THE DRAWINGS

For a better understanding of the present invention, reference is made to a detailed description to be read in conjunction with the accompanying drawings, in which:

FIG. 1 is a flow diagram illustrating a method for inspecting crystal quality of a polysilicon film according to the invention;

FIG. 2 is a schematic of an apparatus for inspecting a polysilicon film according to the invention;

FIG. 3 is a flow diagram illustrating a method for controlling crystal quality of a polysilicon film according to the invention; and

FIG. 4 is a graph showing the relationship between the light intensity ratio (I1/I2′) and the laser energy density (mj/cm²) and the relationship between the light intensity ratio (I1/I2′) and grain size (nm) according to the invention.

### DETAILED DESCRIPTION OF THE INVENTION

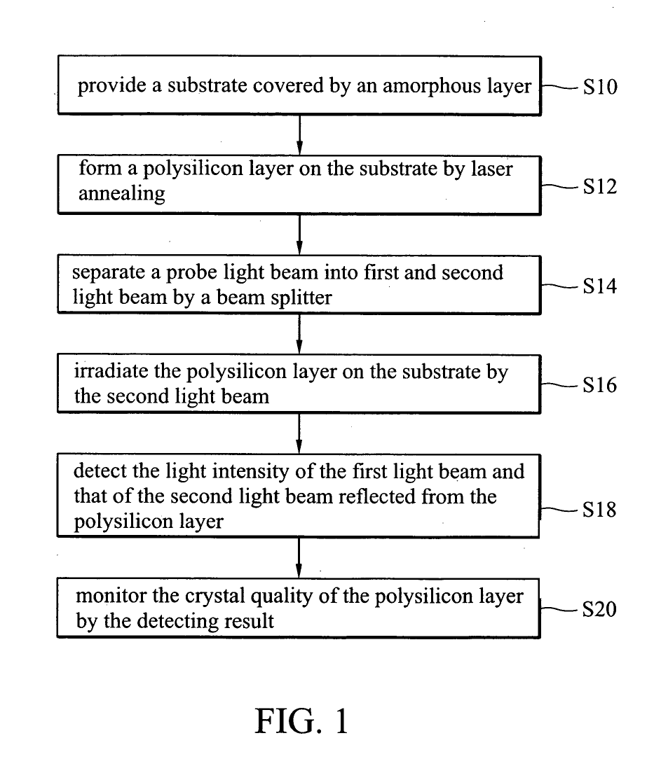

FIG. 1 is a flow diagram illustrating a method for inspecting grain size of a polysilicon film according to the invention. First, in step S10, a substrate, such as a transparent glass substrate, is provided. Moreover, an amorphous silicon layer is formed on the substrate. In this invention, the substrate is used for fabricating a thin film transistor-liquid crystal display (TFT-LCD) and the amorphous silicon layer is used for fabricating the channel layer of the TFT. The amorphous silicon layer has a thickness of about 300˜500 Å and can be formed by conventional deposition, such as chemical vapor deposition (CVD).

Next, in step S12, laser annealing with a predetermined laser energy density is performed on the amorphous silicon layer to transfer it to a polysilicon layer. In this invention, the laser beam for annealing can be an excimer laser beam with a laser energy density of about 300˜500 mJ/cm².

Next, in step S14, a probe light beam, such as a laser beam, is irradiated through a beam splitter to separate into a first light beam and a second light beam. In this invention, the probe light beam has a predetermined wavelength of about 266˜316 nm. Moreover, the split ratio of the first light beam to the second light beam is about 30˜40%:70˜60%.

Next, in step S16, the polysilicon layer on the substrate is irradiated by the second light beam. Thereafter, in step S18, the intensity of the first light beam that is not projected through the polysilicon layer is detected and the light intensity of the second light beam reflected from the polysilicon layer is simultaneously detected.

Finally, in step S20, a light intensity ratio of the light intensity of the first light beam to the light intensity of the second light beam reflected from the polysilicon layer is achieved according to the detected result, thereby monitoring the crystal quality of the polysilicon layer.

The surface roughness (grain size) of the polysilicon layer formed by laser annealing is first increased by increasing the laser energy density, and then the surface roughness is reduced by increasing the laser energy density after the polysilicon layer is formed with the largest grain size. The inventor discovers that the light intensity of the light beam reflected from the polysilicon layer is reduced by increasing the grain size (surface roughness) of the polysilicon layer. Also, the light intensity is increased by reducing the grain size after the polysilicon layer is formed with the largest grain size. Accordingly, the crystal quality of the polysilicon film can be monitored by the light intensity ratio. However, it is difficult to precisely detect the light intensity due to decay or interference in the probe light beam. Therefore, the invention utilizes the light intensity ratio as an index for inspecting crystal quality of the polysilicon film, thereby effectively eliminating the problem.

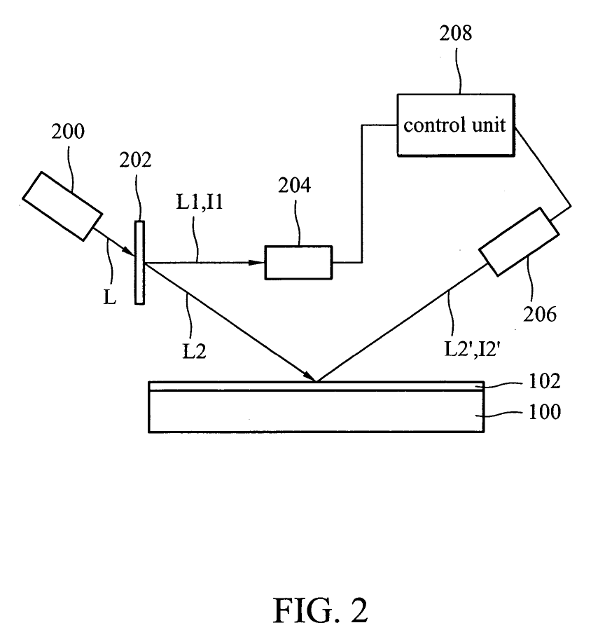

FIG. 2 is a schematic of an apparatus for inspecting crystal quality of a polysilicon film according to the invention. In FIG. 2, a probe light beam L, such as a laser beam, is provided by a light source generator 200 to irradiate a polysilicon layer 202 on a substrate 100, such as a glass substrate. A beam splitter 202 receives the probe light beam L to separate into a first light beam L1 and a second light beam L2. In the invention, the probe light beam L has a predetermined wavelength of about 266˜316 nm. Moreover, the split ratio of the first light beam L1 to the second light beam L2 is about 30˜40%:70˜60%.

The light intensity 11 of the first light beam L1 is detected by a first detecting device 204 and the light intensity 12′ of the second light beam L2′ reflected from the polysilicon layer 102 is detected by a second detecting device 206.

A control unit 208 is coupled between the first and second detecting devices 204 and 206 to monitor the crystal quality of the polysilicon layer 102 according to the light intensity ratio of the first light beam L1 to the reflected second light beam L2′ (I1/I2′).

Since the inspection apparatus of the invention does not destroy the substrate 100 (non-destructive inspection), inspection time and fabrication cost can be reduced. Moreover, the inspection apparatus can be easily integrated with the laser annealing system for in-line inspection. That is, when the grain size of the polysilicon layer is out of specification, the inspection system immediately warns the operator, so the operator can check and promptly regulate the laser energy density, thereby maintaining optimal laser energy density to ensure quality. In addition, the laser annealing is part of the front-end of line (FEOL) process for the low temperature polysilicon (LTPS) process. Accordingly, if an abnormal product is found after inspection, it can be reworked or promptly abandoned, thereby reducing fabrication cost.

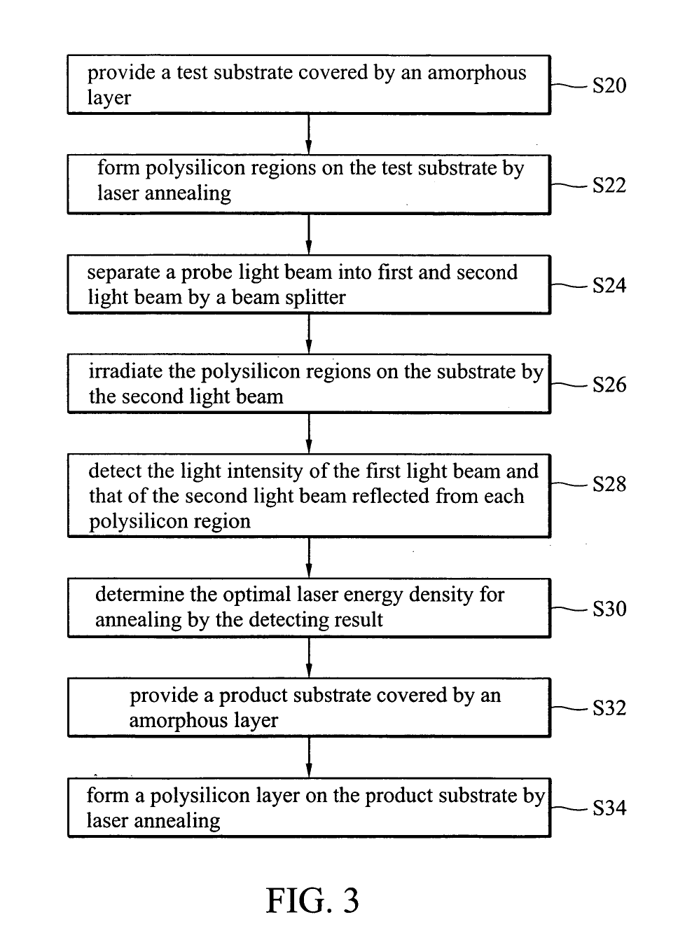

FIG. 3 is a flow diagram illustrating a method of controlling crystal quality of a polysilicon film according to the invention. First, in step S20, a test substrate, such as a transparent glass substrate, is provided. Moreover, an amorphous silicon layer is formed on the test substrate. In this invention, the test substrate is used for pre-testing.

Next, in step S22, laser annealing (ELA) with different predetermined laser energy densities is performed on the amorphous silicon layer over the test substrate to form a plurality of polysilicon regions therein. In this invention, the laser beam for annealing can be an excimer laser beam with a laser energy density of about 300˜500 mJ/cm².

Next, in step S24, the probe light beam L provided by the light source generator 200 shown in FIG. 2 irradiates through the beam splitter 202 to separate into the first light beam L1 and the second light beam L2. The probe light beam L has a predetermined wavelength of about 266˜316 nm. Moreover, the split ratio of the first light beam L1 to the second light beam L2 is about 30˜40%:70˜60%.

Next, in step S26, the second light beam L2 irradiates the polysilicon regions in the test substrate. Thereafter, in step S28, the light intensity I1 of the first light beam L1 without irradiating the polysilicon regions is detected by the first detecting device 204 and the light intensity I2′ of the second light beam L2′ reflected from the polysilicon regions is detected by the second detecting device 206.

Next, in step S30, since the laser energy densities applied to the amorphous silicon layer over the test substrate vary, the quality of each crystal of the polysilicon regions over the test substrate also vary. Accordingly, the light intensity ratios can be achieved by the control unit 208 according to the detecting results, and then an optimal laser energy density for annealing can be determined from the light intensity ratios.

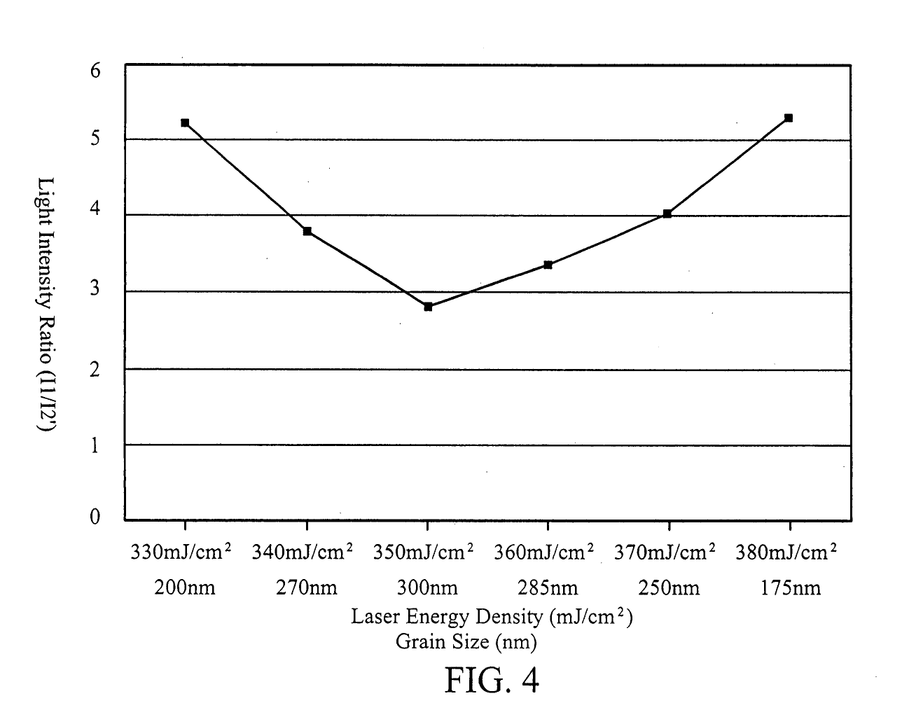

For example, a test substrate having an amorphous silicon layer thereon is provided. Next, laser annealing is performed on the amorphous silicon layer under different predetermined laser energy densities, such as 330 mJ/cm², 340 mJ/cm², 350 mJ/cm², 360 mJ/cm², 370 mJ/cm², and 380 mJ/cm² to form a plurality of polysilicon regions having different crystal quality therein. Next, each polysilicon region is inspected to obtain the relationship between the light intensity ratio (I1/I2′) and the laser energy density (mj/cm²) and the relationship between the light intensity ratio (I1/I2′) and grain size (nm), as shown in FIG. 4. In FIG. 4, the polysilicon region formed by laser annealing with a predetermined laser energy density of about 350 mJ/cm² has the largest grain size (300 nm). That is, the optimal laser energy density is about 350 mJ/cm².

Next, in step S32, a product substrate, such as a transparent glass substrate, is provided. Moreover, an amorphous silicon layer is formed on the product substrate. In this invention, the product substrate is used for fabricating a TFT-LCD and the amorphous silicon layer is used for fabricating the channel layer of the TFT.

Finally, in step S34, laser annealing with the optimal laser energy density (350 mJ/cm²) is performed on the amorphous silicon layer to transfer it to a polysilicon layer having a controlled grain size (crystal quality). Moreover, steps S14 to S20 can proceed for in-line inspection. Also, when the grain size of the polysilicon layer is out of specification, the inspection system immediately warns the operator, so the operator can check and promptly adjust the laser energy density, thereby maintaining the optimal laser energy density to ensure quality.

Compared with the prior art, the in-line inspection of the invention can quickly and precisely monitor the crystal quality of the polysilicon layer, thereby increasing throughput and yield. Moreover, since the inspection of the invention is non-destructive inspection, inspection time and fabrication cost can be reduced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for inspecting crystal quality of a polysilicon film, comprising the steps of:
providing a substrate covered by a polysilicon layer;
irradiating a light beam having a predetermined wavelength through a beam splitter to separate into a first light beam and a second light beam, for irradiating the polysilicon layer;
detecting the light intensity of the first light beam and the light intensity of the second light beam reflected from the polysilicon layer to achieve a light intensity ratio; and
monitoring crystal quality of the polysilicon layer by the light intensity ratio.

2. The method as claimed in claim 1, wherein the substrate is a glass substrate.

3. The method as claimed in claim 1, wherein the light beam is a laser beam and the predetermined wavelength is about 266˜316 nm.

4. The method as claimed in claim 3, wherein a split ratio of the first light beam to the second light beam is 30˜40%:70˜60%.

5. An apparatus for inspecting crystal quality of a polysilicon film, comprising:
a probe light beam having a predetermined wavelength for irradiating a polysilicon layer formed on a substrate;
a beam splitter for receiving the probe light beam to separate into a first light beam and a second light beam, which is used for irradiating the polysilicon layer;
a first detecting device for detecting the light intensity of the first light beam; and
a second detecting device for detecting the light intensity of the second light beam reflected from the polysilicon layer.

6. The apparatus as claimed in claim 5, further comprising a controlling unit coupled between the first and second detecting devices to monitor crystal quality of the polysilicon layer by a light intensity ratio of the first light beam to the second light beam reflected from the polysilicon layer.

7. The apparatus as claimed in claim 5, wherein the probe light beam is a laser beam and the predetermined wavelength is about 266˜316 nm.

8. The apparatus as claimed in claim 5, wherein the substrate is a glass substrate.

9. The apparatus as claimed in claim 5, wherein a split ratio of the first light beam to the second light beam is 30˜40%:70˜60%.

10. A method for controlling crystal quality of a polysilicon film, comprising the steps of:
providing a first substrate covered by a first amorphous silicon layer;
annealing the first amorphous silicon layer by a laser beam with different first predetermined laser energy densities to form a plurality of polysilicon regions therein;
irradiating a probe light beam having a predetermined wavelength through a beam splitter to separate into a first light beam and a second light beam, for irradiating the polysilicon regions;
detecting the light intensity of the first light beam and the light intensity of the second light beam reflected from each polysilicon region to achieve a plurality of light intensity ratios;
determining a second predetermined laser energy density by the light intensity ratios;
providing a second substrate covered by a second amorphous silicon layer; and
annealing the second amorphous silicon layer by the laser beam with the second predetermined laser energy density to form a polysilicon layer on the second substrate.

11. The method as claimed in claim 10, wherein the first and second substrates are glass substrates.

12. The method as claimed in claim 10, wherein the laser beam is an excimer laser beam.

13. The method as claimed in claim 12, wherein the first predetermined laser energy densities are about 300˜500 mJ/cm².

14. The method as claimed in claim 10, wherein the probe light beam is a laser beam and the predetermined wavelength is about 266˜316 nm.

15. The method as claimed in claim 10, wherein a split ratio of the first light beam to the second light beam is 30˜40%:70˜60%.

16. The method as claimed in claim 10, wherein the second predetermined laser energy density is one of the first laser energy densities which can form the polysilicon layer with the largest grain size.
